(19) United States
(12) Patent Application Publication
(10) Pub. No.: US 2012/0199678 A1
(43) Pub. Date: Aug. 9, 2012

(54) IMPROVEMENTS IN MACHINES FOR SHREDDING VARIOUS MATERIALS SUCH AS BLOCKS OF PLASTICS, WOOD RESIDUES, CARDBOARD PACKAGING AND SO FORTH

(76) Inventors: Stefano Cassani, Imola (IT); Diego Mengoli, Budrio (IT)

(21) Appl. No.: 13/502,903

(22) PCT Filed: Oct. 15, 2010
(86) PCT No.: PCT/EP10/65561

§ 371 Date: Apr. 19, 2012

(51) Int. Cl. B02C 18/18; B02C 23/08

(52) U.S. Cl. 241/69; 241/220

(57) ABSTRACT

A machine for shredding various materials, such as blocks of plastics, wood residues, cardboard packaging, building materials and so forth, comprising a rotor constituted by a cylindrical roller and a plurality of shredding teeth, arranged in respective slots, which are provided in the surface of the roller and lie on radial planes which are perpendicular to the axis of rotation of the roller, the shredding teeth comprising cutting elements constituted by plates and blocks for fixing the plates and cooperating with stationary teeth arranged in a comb-like arrangement, the plates being arranged directly on the slots provided in the surface of the roller and the blocks being accommodated in cavities shaped like seats for a key, which are formed in the surface of the roller in line with the slots and lie at right angles to them, the blocks being fixed by means of screws so that they can be removed from the seats and protruding from the slots with a portion that acts for the plates as an element for abutment and fixing by means of screws.

### TECHNICAL FIELD

The present invention relates to improvements in machines for shredding various materials, such as blocks of plastics, wood residues, cardboard packaging, building materials and so forth.

### BACKGROUND ART

Machines for shredding various materials are already known which comprise a cylindrical roller provided with shredding teeth that are distributed upon it along a plurality of axial lines and which cooperate with stationary teeth that are aligned in a comb-like arrangement. Machines of this type are for example known from EP 387868 and from US 2004118958. In the known machines the shredding teeth are constituted by blocks (called anchor-plates) which in general are secured by welding inside respective slots that are provided on the surface of the roller and lie on planes that are radial to the axis of rotation of the roller. To each block a quadrangular plate is fixed, by means of a screw, such plate lying on the plane that is perpendicular to the slot, having a corner that protrudes radially from the surface of the roller and acting as the cutting element of the shredding tooth.

A drawback in the shredding machines of the type mentioned above is the fact that, owing to the welding with which the blocks are fixed in the slots, as well as to a weakness of the joint with possible consequent breakages, distortions arise and the plates can be subjected to angular or longitudinal shifts which determine excessive levels of play with the stationary teeth, with reduction of a good cutting performance, or which instead cause impacts against the stationary teeth or even abutment between the shredding teeth and the stationary teeth and thus blocking of the rotor.

To overcome these drawbacks some producers have adopted blocks which are fixed not by welding, but with screws, which lie on a plane that is which are fixed not by welding, but with screws, which lie on a plane that is radial with respect to the axis of the rotor and which support the plates. Since such plates lie on a slot that is not provided directly on the roller, but on the block, these screws have inaccuracies of positioning with respect to the stationary teeth.

### DISCLOSURE OF THE INVENTION

The aim of the present invention is to provide a machine for shredding various materials, such as blocks of plastics, wood residues, cardboard packaging, building materials and so forth, which makes it possible to overcome the above-mentioned drawbacks which are a feature of the traditional machines.

Within this aim, an object of the present invention is to provide a machine for shredding various materials, in which the precision of positioning the plates with respect to the stationary teeth is ensured, while at the same time ensuring the increased robustness of the plate/block/roller assembly.

Another object of the present invention is to provide a machine for shredding various materials that allows a fine-tuning adjustment of the shredding teeth with respect to the stationary teeth and a simple replacement of the worn teeth.

This aim and these and other objects which will become better apparent hereinafter are achieved by a machine for shredding various materials, such as blocks of plastics, wood residues, cardboard packaging, building materials and so forth, comprising a rotor constituted by a cylindrical roller and a plurality of shredding teeth, arranged in respective slots, which are provided on the surface of the roller and lie on radial planes which are perpendicular to the axis of rotation of the roller, said shredding teeth comprising cutting elements constituted by plates and blocks for fixing the plates and cooperating with stationary teeth arranged in a comb-like arrangement, characterized in that said plates are arranged directly on said slots provided in the surface of said roller and said blocks are accommodated in cavities shaped like seats for a key, which are formed in the surface of the roller in line with said slots and lie at right angles to them, said blocks being fixed by means of screws so that they can be removed from said seats and protruding from said slots with a portion that acts as an element for abutment and fixing for said plates by means of screws.

### BRIEF DESCRIPTION OF THE DRAWINGS

Further characteristics and advantages of the present invention will become better apparent from the following detailed description of an embodiment, illustrated by way of non-limiting example, in the accompanying drawings, wherein:

FIG. 1 is a perspective view of a machine for shredding according to the invention;

FIG. 2 is a perspective view of the machine of FIG. 1 with a shredding tooth in an exploded view;

FIG. 3 is an enlarged view of the shredding tooth of the preceding figures;

FIG. 4 is a view of the attachment block of a cutting element of the machine;

FIGS. 5 and 6 are two views of a portion of the rotor and of some teeth in two staggered positions after a rotation of 45°;

FIGS. 7 and 8 are two sectional views of the rotor which illustrate two respective adjustments of the stationary teeth;

FIG. 9 is a sectional view of a cutting element in three different states of wear a,b,c.

### WAYS OF CARRYING OUT THE INVENTION

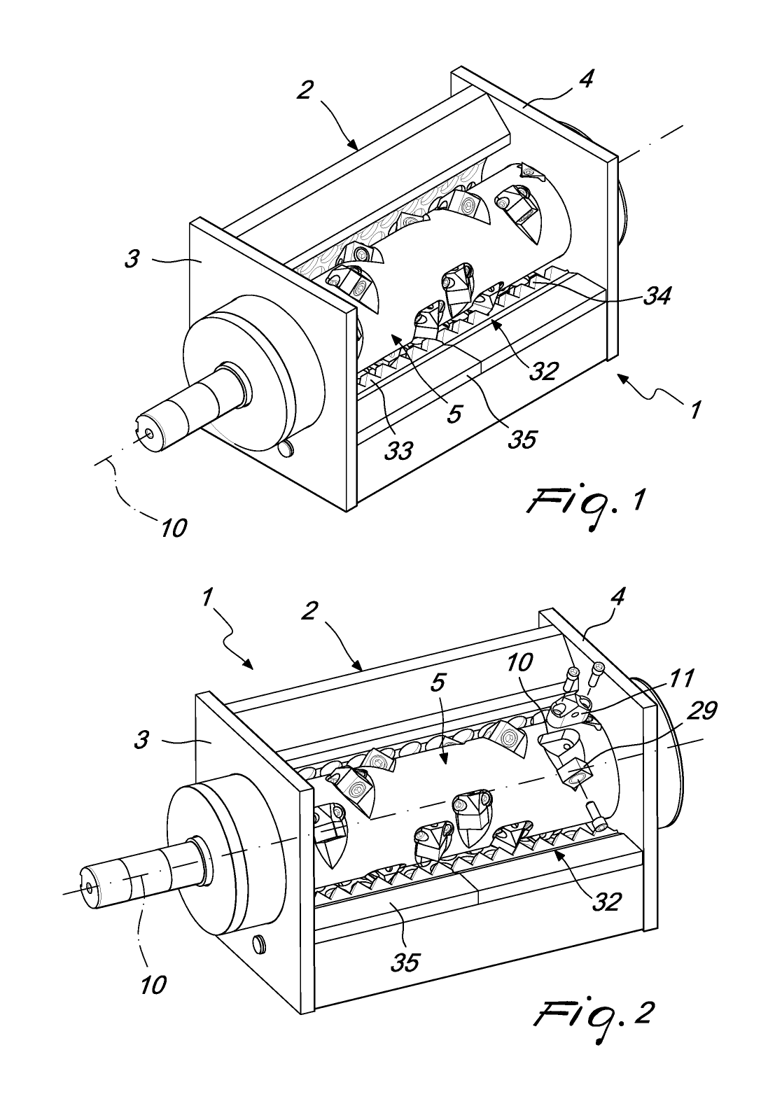

With reference to FIGS. 1 and 2, the reference numeral 1 generally designates a machine for shredding according to the invention, composed of a box-like body 2 that has two sides 3, 4 in which the opposite ends of a cylindrical rotor 5 with axis A are supported. The box-like body 2 is associated on top with a hopper for containing the material to be shredded together with a pusher which is not shown in the drawings.

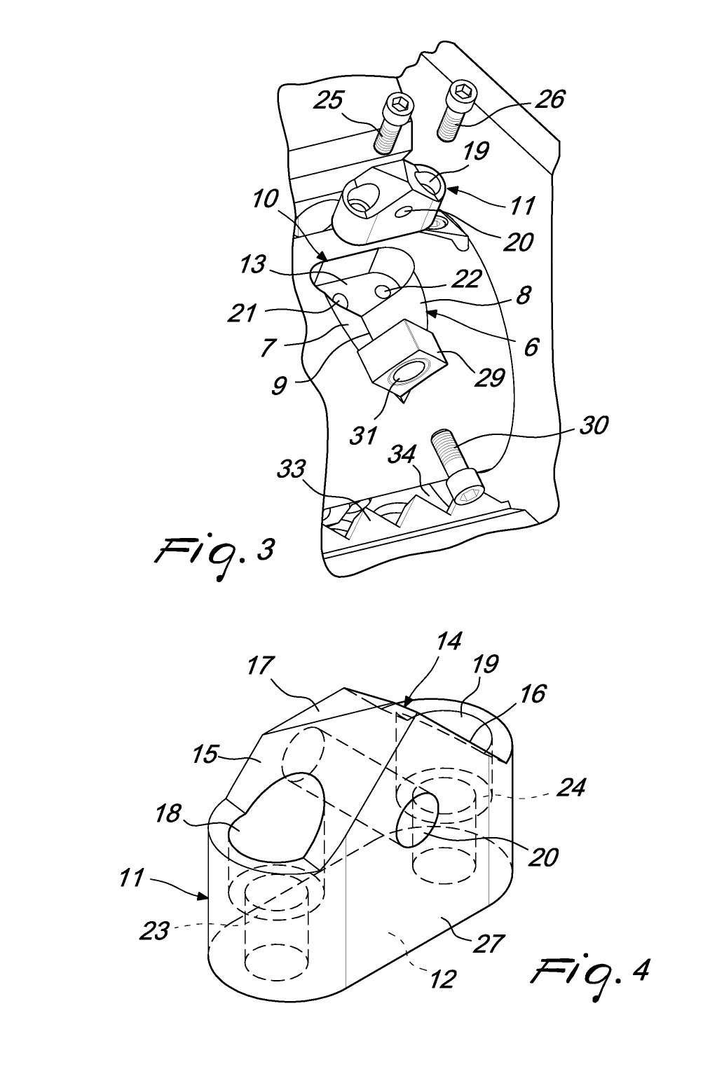

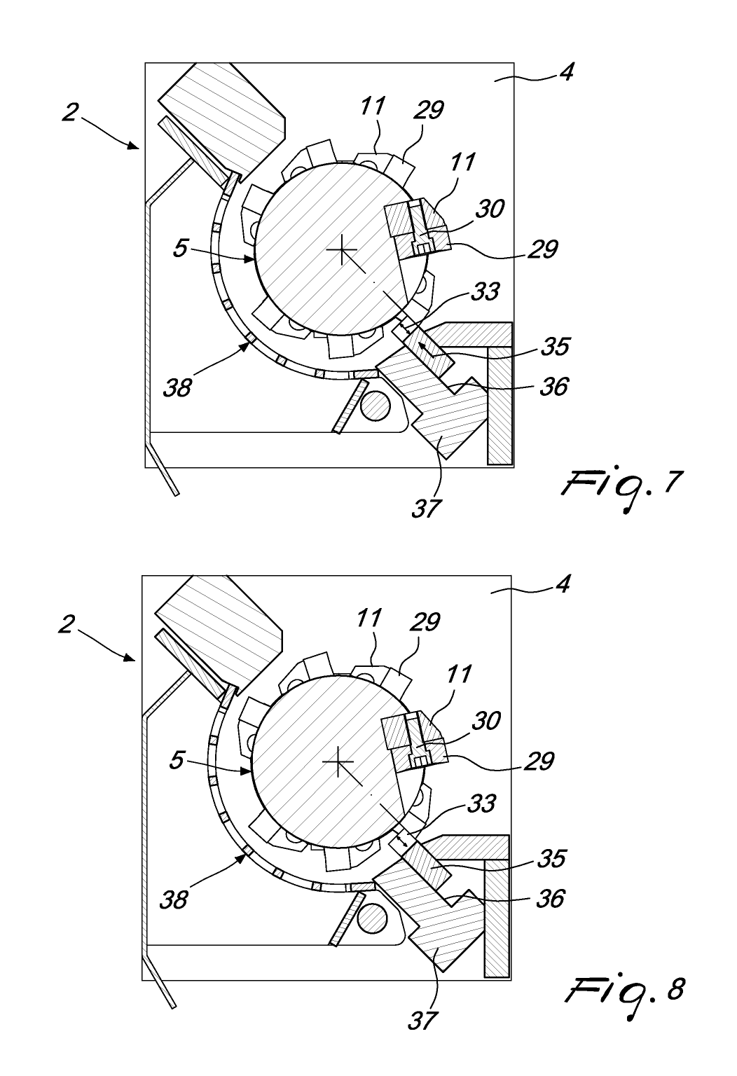

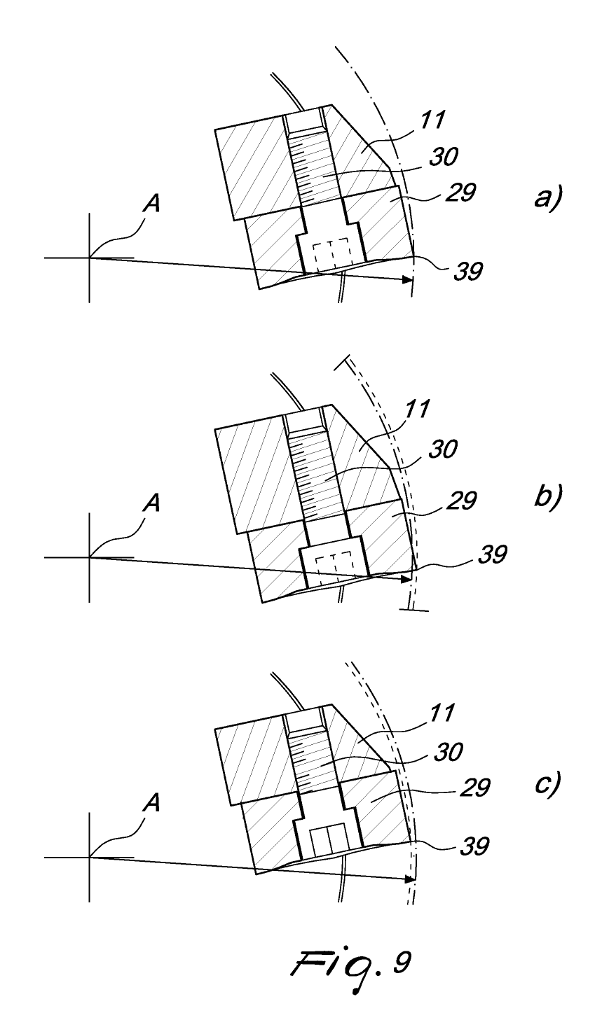

A plurality of slots 6 are distributed on the surface of the rotor 5 in which the shredding elements of the machine are accommodated, only one of which shall be described hereinafter for economy of description. The slots 6, as is made clear by FIG. 3, have a V-shaped section with two opposing faces 7, 8 which form a 90° angle and trace a line 9 that is oblique with respect to the axis A of the rotor 5 and perpendicular to the latter. As is made clear by FIGS. 7 and 8, the slot 6 does not pass through the rotor 5, but leads into a seat 10 provided substantially radially in the rotor 5 for a depth that is greater than the depth of the slot, The seat 10 is shaped like a cavity for a key or tab, so as to have two parallel walls which are perpendicular to the faces 7, 8 and are joined at their opposite ends by semicylindrical curves, The seat 10 (see FIGS. 3, 4) accommodates a block 11 (hereinafter referred to as an anchor-plate) whose cross-section is complementary to the cross-section of the seat 10 so that it can be inserted in the seat without appreciable play. The block 11 has a lower end 12 which is flat so as to be placed on the bottom 13 of the seat 10 and an upper end which forms a raised portion 14 bevelled on three faces of which two faces 15, 16 are convergent and form an angle of 90° which is identical to, but mirror-symmetrical to the angle formed by the faces 7, 8 of the slot 6, whereas the third face 17 is bevelled so as to cut the faces 15, 16 and taper the raised portion 14 on the side facing the slot 6.

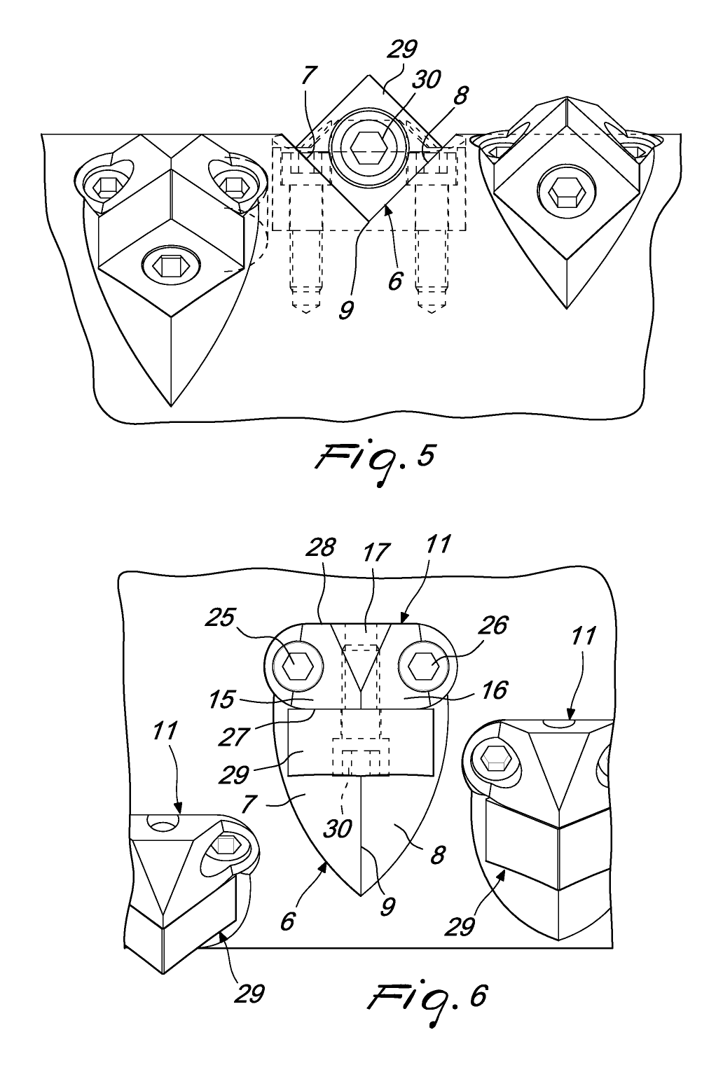

The block 11 is crossed by a pair of through holes 18, 19 and by a third threaded hole 20 which is perpendicular to them. The holes 18, 19 pass through the inside of the rounded sides of the block 11 and are aligned with respective threaded holes 21, 22 provided in the bottom 13 of the seat. Moreover, the holes 18, 19 comprise two portions having a differentiated diameter which form a shoulder 23, 24 for the abutment of screws 25, 26 which are adapted to engage the holes 21, 22 so as to push the block 11 into the seat 10. The geometry of the block 11 is chosen in such a way that, once the block 11 is inserted in the seat 10, its parallel walls 27, 28 (see FIG. 6) are perpendicular to the faces 7, 8 of the slot 6, and in particular the threaded hole 20 is perpendicular to the wall 27 that is directed toward the slot 6 and therefore parallel to the bottom line 9 of the slot.

When the block is inserted into the seat 10, the faces 15, 16 and 7, 8 delimit a portion of the wall 27 which is rhomboidal with respect to the axis of the rotor and at the centre of which the through hole 20 is located. The rhomboid portion of the wall 27 acts as an abutment for the cutting element of the shredding machine. This element is constituted by a plate 29 of hard material and has a shape and size that are substantially identical to those of the above-mentioned rhomboid portion of the wall 27. The plate 29 is fixed with perfect rhomboidal overlapping to the block 11 by means of a screw 30 driven through a central hole 31 and screwed into the hole 20 of the block in such a way that the plate can protrude outside the surface of the rotor, and perform the function of shredding and stirring the material which will be introduced into the machine. Advisably the hole 31 has an entry diameter that is such as to allow the head of the screw 30 to remain recessed and therefore protected during processing.

The machine as described is completed by a sort of comb 32 (see

FIGS. 1, 2) which is provided with a plurality of adjacent teeth 33 which are separated by interspaces 34. The teeth and the interspaces have a triangular shape which is complementary to the shape of the plates 29 and are formed in a robust plate 35 (see also FIGS. 7, 8) which is adjustably supported in a seat 36 of a bar 37 which is fixed between the sides 3, 4 of the machine. The teeth 33 of the comb 32 are substantially radial with respect to the axis A of the rotor 5 and are positioned with precision to allow the plates 29 to pass through the interspaces 34 with minimal play with respect to the teeth.

A semicylindrical grille 38 is associated below the bar 37 and extends around the rotor 5. The grille 38 performs the double function of allowing the discharge of the shredded material into an underlying container (not shown in the drawings) and to recirculate, for a further shredding process, the material whose fragment size is larger than required.

The functioning of the machine according to the invention will be entirely clear from the foregoing description. In particular, attention is drawn to the fact that the precision of positioning the plate 29 with respect to the stationary teeth 33 is ensured by its accommodation in the slot 6 which is provided directly on the surface of the rotor and by the abutment on the block 11, whose precision of positioning on the rotor is guaranteed by its being recessed in the seat 10 and by its locking by means of the screws 25, 26, unlike in traditional shredders in which the blocks for supporting the cutting elements, if fixed by welding, are subjected to thermal deformations which have repercussions on the cutting elements of the rotor, modifying its configuration and compromising the passage between the teeth of the comb. If fixed with screws which lie on a plane that is radial with respect to the axis of the rotor and which support the cutting elements, then the cutting elements, by lying on a slot that is not provided directly on the rotor but on the block itself, will have inaccuracies of positioning with respect to the stationary teeth.

Similarly, a significant advantage of the invention can be seen in the formation of the seat 10 for the slot-in accommodation of the block 11. Indeed this seat, being substantially constituted by a radial cavity of the rotor, can be implemented with simple mechanical operations which make it possible to shorten the intersecting path of the slot 6 and thus create a firm abutment at the wall 28 of the block which can offer a greater resistance to the pushing stresses which are brought to bear on the block during shredding.

Moreover, shortening of the slot 6 makes it possible to move the position of the plate 29 until the cutter 39 is brought to meet the diameter of the rotor (see portion a of FIG. 9) with the significant advantage that the cutter of the plate, whether it be new or of greater thickness (see portion b of FIG. 9), or worn (see portion c of FIG. 9), maintains the external dimensions within tolerances that do not compromise the passage between the teeth of the comb.

According to a further advantage of the invention, fixing the block 11 by means of screws makes it possible to adapt the machine to the characteristics of the material to be shredded. Indeed, simply by removing the screws 25, 26 it is possible to substitute the block and plate with other, similar elements, which however have shapes and dimensions that can provide cutting and crushing performance levels optimal with respect to the speed of the rotor.

In the practical embodiment of the invention the shapes and dimensions of the machine as described as well as the materials used can vary according to requirements.

The disclosures in Italian Patent Application No. BO2009A000690 from which this application claims priority are incorporated herein by reference.

Where technical features mentioned in any claim are followed by reference signs, those reference signs have been included for the sole purpose of increasing the intelligibility of the claims and accordingly, such reference signs do not have any limiting effect on the interpretation of each element identified by way of example by such reference signs.

1-9. (canceled)

10. A machine for shredding various materials, such as blocks of plastics, wood residues, cardboard packaging, building materials and so forth, comprising a rotor constituted by a cylindrical roller and a plurality of shredding teeth, arranged in respective slots, which are provided in a surface of the roller and lie on radial planes which are perpendicular to an axis of rotation of the roller, said shredding teeth comprising cutting elements constituted by plates and blocks for fixing the plates and cooperating with stationary teeth arranged in a comb-like arrangement, wherein said plates are arranged directly on said slots provided in the surface of said roller and said blocks are accommodated in cavities shaped like seats for a key, which are formed in the surface of the roller in line with said slots and lie at right angles to them, said blocks being fixed by means of screws so that they can be removed from said seats and protruding from said slots with a portion that acts for said plates as an element for abutment and fixing by means of screws.

11. The machine according to claim 10, wherein said slots have a V-shaped cross-section with two mutually opposite faces which form a 90° angle and define a bottom line that is oblique with respect to the axis of the rotor and perpendicular to the latter, said slots being connected to said respective seats provided substantially radially in the rotor for a depth that is greater than the depth of said slots.

12. The machine according to claim 11, wherein each seat is shaped like a cavity for a key, so as to have two parallel walls which are perpendicular to the faces of said slot, said seat accommodating a block whose cross-section is complementary to the cross-section of the respective seat, so that it can be inserted in said seat without appreciable play, and an upper end which forms a raised portion which is bevelled so as to have two converging faces which form a 90° angle which is identical but mirror-symmetrical with respect to the angle formed by the faces of said slot, said block being crossed by a pair of through holes and by a third threaded hole which is perpendicular to them, said through holes being aligned with respective threaded holes provided in the bottom of said seat for the engagement of screws for locking said block in said seat and said third threaded hole being adapted to be engaged by a screw for fixing a cutting element which is associated with said block.

13. The machine according to claim 12, wherein said through holes comprise two portions having a differentiated diameter, which form a shoulder for the abutment of said locking screws.

14. The machine according to claim 12, wherein when said block is inserted in the respective seat, parallel walls thereof are perpendicular to the faces of the slot, and wherein said third threaded hole is perpendicular to the wall of the block that is directed toward said slot and parallel to the bottom line of said slot, which is formed by said faces.

15. The machine according to claim 14, wherein said cutting element is constituted by a plate, whose shape and dimensions are substantially rhomboidal and which is adapted to overlap a rhomboidal portion of said block that is complementary thereto, a screw being further provided which is driven centrally through said plate and screwed into the third threaded hole of said block so that said plate protrudes outside the surface of the rotor.

16. The machine according to claim 15, further comprising a comb-like element, which is provided with a plurality of adjacent teeth separated by interspaces, said teeth and interspaces having a triangular shape which is complementary to the shape of said plates.

17. The machine according to claim 16, wherein said teeth and said interspaces are provided in a plate which is supported adjustably in a seat of a bar which is jointly connected to fixed parts of said machine, said teeth being substantially radial with respect to the axis of the rotor and arrangeable so as to allow said plates to pass through said interspaces with minimal play with respect to the teeth.

18. The machine according to claim 17, wherein a semicylindrical grille is associated below said bar and extends around the rotor, said grille being adapted to allow the discharge of the shredded material into an underlying container and to recirculate, for a further shredding process, the material whose fragment size is larger than required.
